(19) United States
(12) Patent Application Publication
(10) Pub. No.: US 2026/0321779 A1
(43) Pub. Date: Oct. 15, 2026

(54) HEAT EXCHANGE STRUCTURE, BATTERY PACK AND ELECTRIC DEVICE

(71) Applicant: BYD COMPANY LIMITED, Shenzhen (CN)

(72) Inventors: Jing FU, Shenzhen (CN); Haitao ZHANG, Shenzhen (CN); Tingting ZHU, Shenzhen (CN); Junjie ZHU, Shenzhen (CN); Xueye LIN, Shenzhen (CN)

(21) Appl. No.: 19/465,842

(22) Filed: Jan. 30, 2026

Related U.S. Application Data
(63) Continuation of application No. PCT/CN2024/077523, filed on Feb. 19, 2024.

(30) Foreign Application Priority Data
Jul. 31, 2023 (CN) 202322046003.6

(51) Int. Cl. H01M 10/6554; F28F 3/12; H01M 50/204; H01M 50/271

(52) U.S. Cl. CPC H01M 10/6554; F28F 3/12; H01M 50/204; H01M 50/271

(57) ABSTRACT

In one aspect, a heat exchange structure includes a first plate and a second plate, wherein the first plate is provided with a first recess, the first recess being defined by a first bottom wall and a first side wall of the first plate; and wherein the second plate is provided with a second recess, the second recess being defined by a second bottom wall and a second side wall of the second plate. The first bottom wall and the second bottom wall are at least partially spaced apart so as to form a flow channel, the first side wall is connected to the second side wall, and the first recess of the first plate is configured to contain battery cells.

### CROSS-REFERENCE TO RELATED APPLICATIONS

The present application is a bypass continuation of International Patent Application No. PCT/CN2024/077523, filed on Feb. 19, 2024, which in turn is based on and claims the right of priority to Chinese Patent Application No. 202322046003.6, filed on Jul. 31, 2023. The entire contents of both of the above-referenced applications are hereby incorporated into this application by reference for all purposes.

### FIELD

The present application relates to the field of battery technology, particularly to a heat exchange structure, a battery pack and an electric device.

### BACKGROUND

In the prior art, power batteries typically utilize coolers welded to a tray-type profile frame to dissipate heat from the cells. The tray is usually constructed from aluminum alloy extruded profiles through welding. However, the tray's structural profile frame is heavy, expensive, and the weld seam between the cooler and the tray exhibits poor air tightness.

### SUMMARY

In various aspects, this application provides a new technical solution for a heat exchange structure, a battery pack and an electric device, which can solve one or more problems in the prior art, such as the need in the prior art for separate battery trays, which results in a heavy overall structure and high cost.

In one aspect, the heat exchange structure provided in this application includes: first plate, a first recess arranged at the first plate, the first recess being defined by a first bottom wall and a first side wall of the first plate; a second plate, a second recess arranged at the second plate, the second recess being defined by a second bottom wall and a second side wall of the second plate, the first bottom wall and the second bottom wall being at least partially spaced apart to form a flow channel, the first side wall being connected to the second side wall, and the first recess of the first plate being configured to contain battery cells.

In addition, the vehicle according to the above embodiments of the present application may further have the following additional technical features:

According to an embodiment of this application, a protrusion is arranged at the second bottom wall, the protrusion abuts against the first bottom wall, and the first bottom wall and the protrusion are at least partially spaced apart to form the flow channel.

According to an embodiment of this application, a flow channel groove is arranged on the protrusion, and the flow channel groove and the first bottom wall jointly define the flow channel.

According to an embodiment of this application, there are plurality of protrusions, and each protrusion extends along a portion (e.g., a curve) of the second bottom wall.

According to an embodiment of this application, the portion of the second bottom wall excluding the protrusion is spaced apart from the first bottom wall to form a cavity, and a filler is arranged inside the cavity.

According to an embodiment of this application, the first side wall and the second side wall are partially spaced apart, and the second bottom wall and the second side wall cooperate with the first bottom wall and the first side wall to form an annular cavity, wherein the filler is an annular filling block corresponding to the annular cavity.

According to an embodiment of this application, the side of the second bottom wall facing away from the first bottom wall is formed with a recessed area corresponding to the protrusion, and a cushioning member is arranged within the recessed area.

According to an embodiment of this application, the side of the second bottom wall facing away from the first bottom wall is formed with a recessed area corresponding to the protrusion, a cushioning member is arranged at the side of the second bottom wall facing away from the first bottom wall, and a part of the cushioning member is located within the recessed area.

According to an embodiment of this application, the heat exchange structure further includes a bottom guard plate, and the bottom guard plate is connected to the side of the second bottom wall facing away from the first bottom wall.

According to an embodiment of this application, the bottom guard plate is fixedly connected to the part of the second bottom wall excluding the recessed area, and the bottom guard plate abuts against the cushioning member.

According to an embodiment of this application, a first protruding edge extending away from the first recess is arranged on the first side wall, and a second protruding edge extending away from the second recess is arranged on the second side wall of the second plate, the first protruding edge and the second protruding edge are connected and configured for connecting to external structures.

According to an embodiment of this application, the second protruding edge is arranged on the side of the first protruding edge close to the second bottom wall, the first protruding edge and the second protruding edge are arranged opposite each other, and the first protruding edge and the second protruding edge are fixedly connected.

According to a battery pack provided in this application, the battery pack includes the heat exchange structure described in the above embodiments.

According to an embodiment of this application, the battery pack further includes: a battery cell, which is installed and arranged within the first recess; and a cover plate, wherein the cover plate is covered on the first plate.

According to an electric device provided in this application, the electric device includes the heat exchange structure described in the above embodiments; or the electric device includes the battery pack described in the above embodiments.

In the heat exchange structure of this application, by arranging a first recess the first plate and a second recess on the second plate, the first bottom wall of the first plate and the second bottom wall of the second plate can be spaced apart to form a flow channel, and the first plate and the second plate can constitute a cooler. At the same time, the battery cells are placed in the first recess to achieve cooling and heat dissipation. The first plate and the second plate are integrated into a heat exchange structure with dual functions of a tray and a cooler, eliminating the tray structure, reducing weight and cost, and improving the air tightness of the heat exchange structure.

Through the detailed description of the exemplary embodiments of the present application with reference to the accompanying drawings, other features and advantages of the present application will become clear.

### BRIEF DESCRIPTION OF THE DRAWINGS

The accompanying drawings incorporated in and constituting a part of the specification illustrate embodiments of the present application and, together with the description, serve to explain the principles of the present application.

FIG. 1 shows a schematic diagram of a heat exchange structure according to an embodiment of the present application;

FIG. 2 shows an exploded schematic diagram of a heat exchange structure according to an embodiment of the present application;

FIG. 3 shows another schematic diagram of a heat exchange structure according to an embodiment of the present application;

FIG. 4 shows a cross-sectional diagram taken along line A-A in FIG. 3;

FIG. 5 shows a partial enlarged diagram of Area B in FIG. 4;

FIG. 6 shows a partial enlarged diagram of Area C in FIG. 4;

FIG. 7 shows a schematic diagram of a battery pack according to an embodiment of the present application.

### DETAILED DESCRIPTION

Various exemplary embodiments of the present application will now be described in detail with reference to the accompanying drawings. It should be noted that the relative arrangement, numerical expressions, and values of the components and steps described in these embodiments do not limit the scope of the present application unless otherwise specified.

The following description of at least one exemplary embodiment is merely illustrative and should not be construed as any limitation on the present application or its application or use.

The techniques, methods, and equipment known to a person having ordinary skill in the relevant art may not be discussed in detail, but in appropriate circumstances, such techniques, methods, and equipment should be considered as part of the specification.

In all the examples shown and discussed herein, any specific value should be interpreted as merely illustrative and not restrictive. Therefore, other examples of exemplary embodiments may have different values.

It should be noted that similar labels and letters represent similar items in the following figures. Therefore, once an item is defined in one figure, it does not need to be further discussed in subsequent figures.

In the specification and claims of this application, if the terms “first” or “second” are involved, one or more of these features may be explicitly or implicitly included. In the specification and claims of this application, unless otherwise specified, the meaning of “multiple” refers to two or more. In addition, in the specification and claims, “and/or” represents at least one of the connected objects, and the character “/” generally indicates an “or” relationship between the related objects.

In the specification and claims of this application, it should be understood that if the terms “center”, “longitudinal”, “transverse”, “length”, “width”, “thickness”, “up”, “down”, “front”, “back”, “left”, “right”, “vertical”, “horizontal”, “top”, “bottom”, “inside”, “outside”, “clockwise”, “counterclockwise”, “axial”, “radial”, “circumferential” are used to indicate the orientation or position relationship based on the orientation or position relationship shown in the accompanying drawings, it is only for the convenience of describing this application and simplifying the description, and it does not indicate or imply that the device or component referred to must have a specific orientation, be constructed and operated in a specific orientation, and therefore cannot be understood as a limitation of the present application.

In the specification and claims of this application, it should be noted that unless otherwise specified and limited, the terms “installation”, “connected”, and “connection” should be broadly understood. For example, it can be a fixed connection, a detachable connection, or an integrated connection; it can be a mechanical connection or an electrical connection; it can be directly connected, indirectly connected through an intermediate medium, or connected internally between two components. For a person having ordinary skill in the art, the specific meanings of the above terms in this application can be understood according to the specific situation.

The heat exchange structure 100 according to the embodiments of the present application will be described in detail with reference to the accompanying drawings.

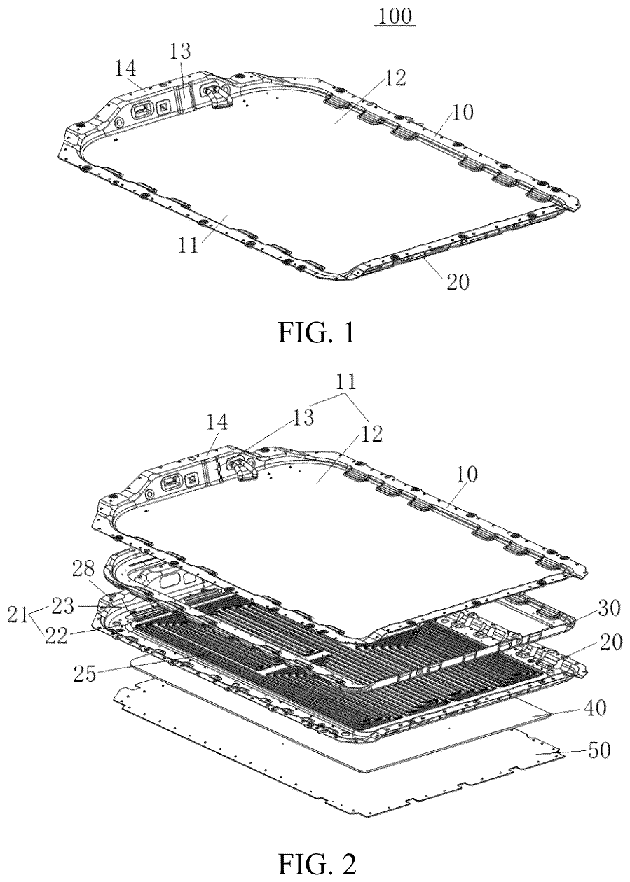

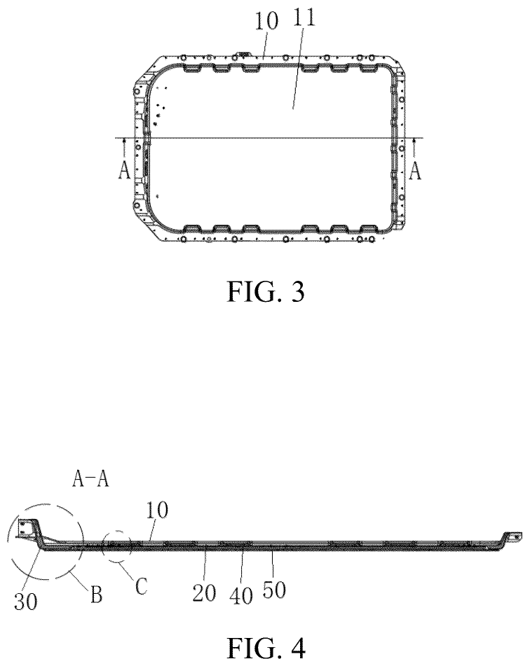

With reference to FIGS. 1-3, the heat exchange structure 100 according to the embodiments of this application includes a first plate 10 and a second plate 20.

A first recess 11 is arranged at the first plate 10, with the first recess 11 being defined by a first bottom wall 12 and a first side wall 13 of the first plate 10. A second recess 21 is arranged at the second plate 20, with the second recess 21 being defined by a second bottom wall 22 and a second side wall 23 of the second plate 20. In addition, the first bottom wall 12 and the second bottom wall 22 are at least partially spaced apart from each other to form a flow channel 29 (FIG. 6), with the first side wall 13 being connected to the second side wall 23, and the first recess 11 of the first plate 10 being configured to contain battery cells 200.

In other words, referring to FIGS. 1-3, the heat exchange structure 100 according to the embodiments of this application includes a first plate 10 and a second plate 20. As shown in FIGS. 1 and 2, a first recess 11 is arranged at the first plate 10, with the first recess 11 being defined by a first bottom wall 12 and a first side wall 13 of the first plate 10. The first bottom wall 12 and the first side wall 13 constitute the first plate 10 with the first recess 11. The first recess 11 of the first plate 10 can be configured to accommodate battery cells 200. A second recess 21 is arranged at the second plate 20, with the second recess 21 being defined by a second bottom wall 22 and a second side wall 23 of the second plate 20. The second bottom wall 22 and the second side wall 23 constitute the second plate 20 with the second recess 21. By connecting and enclosing the first side wall 13 and the second side wall 23 to form a double-layer frame, the strength requirements for anti-impact of tray profile frames in the prior art are achieved, avoiding the problem of insufficient strength of single-layer side walls and the need for additional reinforcement structures.

The first plate 10 is arranged on the second plate 20, and the first bottom wall 12 corresponds to the second bottom wall 22. The first bottom wall 12 and the second bottom wall 22 are at least partially spaced apart to form a flow channel 29. A circulating cooling liquid, such as cooling water or other cooling media, can be introduced into the flow channel 29. The cooling and heat dissipation of the battery cells 200 in the first recess 11 can be achieved by utilizing the cooling liquid in the flow channel 29.

In this application, the heat exchange structure 100 with the flow channel 29 composed of or defined between the first plate 10 and the second plate 20 can not only serve as a cooler to achieve cooling and heat dissipation of the battery cells 200, but also as a heater to heat the battery cells 200. It can also be used as a tray to install and accommodate the battery cells 200. Therefore, the heat exchange structure 100 of the present application integrates the first plate 10 and the second plate 20 into a structure that can achieve the dual functions of a tray and a cooler, eliminates the tray structure, reduces weight and cost, and has good overall air tightness.

In the prior art, the cooler and the tray are two separate structures, with the cooler cooling and dissipating heat from the battery cells 200 inside the tray. The tray is usually made of aluminum alloy extruded profiles that are welded together. The cooler is welded to the tray profile frame to dissipate heat from the battery cells 200. The profile frame is heavy, costly, and the weld seam between the cooler and the tray has poor air tightness. This application directly designs the heat exchange structure 100 into a tray-like shape, achieving diversification of the heat exchange structure's 100 functions without the need for a separate tray. This solves the problems in the prior art, such as the separate setup of trays, which results in heavy weight, high cost, and poor air tightness. At the same time, the first side wall 13 and the second side wall 23 are connected and enclosed to form a double-layer frame, meeting the strength requirements for anti-impact of tray profile frames in the prior art, and avoiding the problem of insufficient strength of single-layer side walls and the need for additional reinforcement structures.

Based on this, according to the heat exchange structure 100 of the embodiments of the present application, by arranging a first recess 11 on the first plate 10 and a second recess 21 on the second plate 20, the first bottom wall 12 of the first plate 10 and the second bottom wall 22 of the second plate 20 can be spaced apart to form a flow channel 29, and the first plate 10 and the second plate 20 can function as or constitute a cooler. At the same time, the battery cells 200 are placed in the first recess 11 to achieve cooling and heat dissipation. The first plate 10 and the second plate 20 are integrated into a heat exchange structure 100 with the dual functions of a tray and a cooler, eliminating the tray structure, reducing weight and cost, and improving the air tightness of the heat exchange structure 100.

According to one embodiment of the present application, a protrusion 24 is arranged at the second bottom wall 22, The protrusion 24 abuts against the first bottom wall 12, and the first bottom wall 12 and the protrusion 24 are at least partially spaced apart to form the flow channel 29.

Specifically, referring to FIGS. 2, 5, and 6, the protrusion 24 is arranged at the second bottom wall 22 of the second plate 20, which is in a large concave-convex shape. The protrusion 24 on the second bottom wall 22 can abut against the first bottom wall 12. Moreover, the first bottom wall 12 of the first plate 10 and the protrusion 24 are at least partially spaced apart to form a flow channel 29 for transmitting cooling liquid, thereby achieving heat dissipation for the battery cells 200 inside the first recess 11. The protrusion 24 and the bottom wall 12 of the first plate 10 can be connected by brazing or other methods. After brazing, failure reshaping can be performed to obtain higher structural strength and improve the overall structural stability and air tightness of the heat exchange structure 100.

According to one embodiment of the present application, a flow channel groove 25 is arranged on the protrusion 24, and the flow channel groove 25 and the first bottom wall 12 jointly define the flow channel 29.

Specifically, referring to FIGS. 2, 5, and 6, a flow channel groove 25 can be arranged on the protrusion 24, and the flow channel groove 25 and the first bottom wall 12 can jointly define the flow channel 29. By circulating cooling liquid through the flow channel 29, the heat from the battery cell 200 inside the first recess 11 is carried away, achieving heat dissipation for the battery cell 200.

According to one embodiment of the present application, a plurality of protrusions 24 can be provided, and each protrusion 24 extends along a portion (e.g., a curve) of the second bottom wall 22.

Specifically, as shown in FIG. 2, a plurality of protrusions 24 can be provided, and each protrusion 24 can extend along the curve of the second bottom wall 22. The flow channel groove 25 on each protrusion 24, together with the first bottom wall 12, respectively define a plurality of flow channels 29. The area enclosed by the plurality of flow channels 29 is approximately equivalent to the area of the first bottom wall 12 of the first recess 11 ensuring uniform heat dissipation for the battery cells 200 inside the first recess 11, thereby further improving the heat dissipation efficiency of the heat exchange structure 100.

In this application, the plurality of flow channels 29 can be U-shaped, circular, or other shapes. The specific shape of the flow channels 29 can be specifically set according to actual needs, and will not be elaborated in detail in this application.

According to one embodiment of the present application, the portion of the second bottom wall 22 excluding the protrusion 24 is spaced apart from the first bottom wall 12 to form a cavity 27, and a filler 30 is arranged inside the cavity 27.

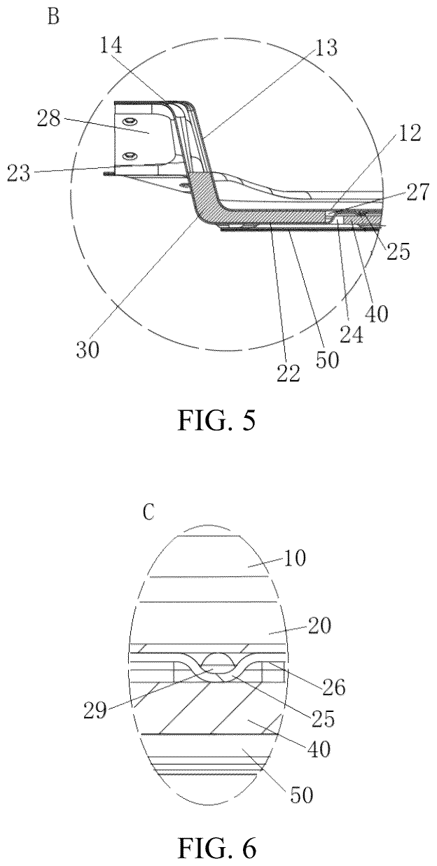

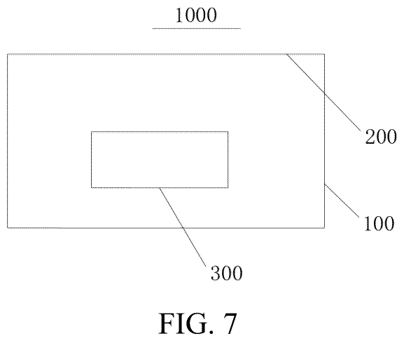

Specifically, referring to FIG. 4 and FIG. 5, the portion of the second bottom wall 22 excluding the protrusion 24 can be spaced apart from the first bottom wall 12 to form a cavity 27. A filler 30 can be arranged inside the cavity 27. By arranging a filler 30 inside the cavity 27, the load-bearing capacity of the first plate 10 and the second plate 20 can be further enhanced, increasing the load-bearing strength of the heat exchange structure 100. This ensures that the overall structure remains more stable after the battery cells are installed relative to the heat exchange structure 100.

According to one embodiment of the present application, the first side wall 13 and the second side wall 23 are partially spaced apart, and the second bottom wall 22 and the second side wall 23 cooperate with the first bottom wall 12 and the first side wall 13 to form the cavity 27. In such an embodiment, the filler 30 is a filling block corresponding to the cavity 27.

Specifically, referring to FIG. 2 and FIG. 5, the first side wall 13 and the second side wall 23 can be partially spaced apart, and the second bottom wall 22 and the second side wall 23 cooperate with the first bottom wall 12 and the first side wall 13 to form the cavity 27. Among them, the cavity 27 can be located approximately at the connection position between the second bottom wall 22 and the second side wall 23 of the second plate 20. The connection position between the second bottom wall 22 and the second side wall 23 of the second plate 20 can be understood as the edge position at the bottom of the second recess 21. The annular cavity 27 is recessed downward relative to the first bottom wall 12 of the first plate 10, and the filler 30 is arranged as a filler block corresponding to the cavity 27 (referring to FIG. 2). The filler block is filled in the cavity 27, effectively increasing the load-bearing strength of the heat exchange structure 100.

By connecting and enclosing the first side wall 13 and the second side wall 23 to form a double-layer frame, the strength requirements for anti-impact of tray profile frames in the prior art are achieved, avoiding the problem of insufficient strength of single-layer side walls and the need for additional reinforcement structures.

The filler 30 in this application can be made of foaming agent or foaming filler rubber. By setting up the filler 30, it can not only improve the load-bearing capacity of the heat exchange structure 100, but also provide good protection for the heat exchange structure 100 due to its light weight, thermal insulation, cushioning, and impact resistance performance.

According to one embodiment of the present application, the side of the second bottom wall 22 facing away from the first bottom wall 12 is formed with a recessed area 26 corresponding to the protrusion 24, and a cushioning member 40 is arranged within the recessed area 26.

Specifically, referring to FIG. 2 and FIG. 6, the side of the second bottom wall 22 facing away from the first bottom wall 12 (e.g., the bottom surface of the second plate 20) is formed with a recessed area 26. The recessed area 26 corresponds to the protrusion 24 on the second bottom wall 22, forming a concave-convex structure on the second bottom wall 22 of the second plate 20, thereby further enhancing the overall structural strength of the second plate 20. Referring to FIG. 2, a cushioning member 40 can be arranged within the recessed area 26. By filling the recessed area 26 of the second bottom wall 22 with the cushioning member 40, it provides thermal insulation, impact resistance, and light weight properties, effectively protecting the bottom of the battery cell 200.

According to one embodiment of the present application, the side of the second bottom wall 22 facing away from the first bottom wall 12 is formed with a recessed area 26 corresponding to the protrusion 24, a cushioning member 40 is arranged at the side of the second bottom wall 22 facing away from the first bottom wall 12, and a part of the cushioning member 40 is located within the recessed area 26.

Specifically, referring to FIGS. 2, 5, and 6, the side of the second bottom wall 22 facing away from the first bottom wall 12 (e.g., the bottom surface of the second plate 20) is formed with a recessed area 26 corresponding to the protrusion 24. A cushioning member 40 is arranged at the side of the second bottom wall 22 facing away from the first bottom wall 12. The cushioning member 40 can be made of foam board or other structures with cushioning functions. The cushioning member 40 can be designed as a plate structure, covering the bottom of the second plate 20, and at the same time, a part of the cushioning member 40 can be filled in the recessed area 26. The cushioning member 40 has properties such as thermal insulation, cushioning, impact resistance, and light weight, which can effectively protect the bottom of the battery cell 200. The cushioning member 40 can be made of thermal insulation and impact resistant materials. The specific shape and thickness of the cushioning member 40 can be specifically set according to actual needs, and will not be elaborated in this application.

In this application, the first plate 10 is a temperature-equalizing plate, and the second plate 20 is a flow channel plate. The first plate 10 and the second plate 20 can be integrally stamped and formed from aluminum plates, integrating the two plates. The first plate 10 and the second plate 20 constitute a heat exchange structure 100 with flow channels 29, which can not only serve as a cooler to achieve cooling and heat dissipation for the battery cells 200, but also function as a tray to install and accommodate the battery cells 200. Therefore, the heat exchange structure 100 of this application integrates the first plate 10 and the second plate 20 into a structure capable of achieving dual functions as a tray and a cooler, eliminating the tray structure and reducing weight and cost.

The welding process of the first plate 10 and the second plate 20 can eliminate the need for self-fusion welding techniques. Instead, the temperature-equalizing plate (first plate 10) and the flow channel plate (second plate 20) can be integrally bonded and brazed together. This brazing process does not compromise the strength of the plate material. After brazing, the entire structure can be straightened and shaped to control deformation and achieve higher strength. Simultaneously, a gap (cavity) is reserved around the temperature-equalizing plate and the flow channel plate for filling with a foaming agent (filler 30), which can significantly enhance the overall load-bearing strength of the heat exchange structure 100. The heat exchange structure 100 of this application replaces traditional trays for supporting the battery cells 200, while also providing cooling and heat dissipation performance. The bottom of the second plate 20 can be coated with protective materials (such as cushioning member 40), which possesses thermal insulation, cushioning, impact resistance, and light weight properties, effectively protecting the bottom of the battery cell 200.

According to one embodiment of the present application, referring to FIG. 2, the heat exchange structure 100 further includes a bottom guard plate 50, with the bottom guard plate 50 being connected to the side of the second bottom wall 22 facing away from the first bottom wall 12. In other words, the heat exchange structure 100 includes a bottom guard plate 50, the bottom guard plate 50 being arranged on the bottom surface of the second plate 20. By providing the bottom guard plate 50, the bottom of the heat exchange structure 100 can be well protected, achieving excellent bottom protection effect.

According to one embodiment of the present application, the bottom guard plate 50 is fixedly connected to the part of the second bottom wall 22 excluding the recessed area 26, and the bottom guard plate 50 is adhesively connected to the cushioning member 40.

Specifically, referring to FIG. 2, the bottom guard plate 50 can be fixedly connected to the part of the second bottom wall 22 excluding the recessed area 26. The connection between the bottom guard plate 50 and the second bottom wall 22 of the second plate 20 can be established through bolt connection, welding, or other types of fixed connections, ensuring a stable connection between the bottom guard plate 50 and the second plate 20 and enhancing the overall stability of the heat exchange structure 100. The bottom guard plate 50 can be adhesively connected to the cushioning member 40, providing effective protection for the battery cell 200.

According to one embodiment of the present application, a first protruding edge 14 extending away from the first recess 11 is arranged on the first side wall 13 of the first plate 10, and a second protruding edge 28 extending away from the second recess 21 is arranged on the second side wall 23 of the second plate 20, with the first protruding edge 14 and the second protruding edge 28 being connected and configured for connecting to external structures.

Specifically, referring to FIG. 1 and FIG. 2, a first protruding edge 14 is arranged on the first side wall 13 of the first plate 10, the first protruding edge 14 extends away from the first recess 11. A second protruding edge 28 is arranged on the second side wall 23 of the second plate 20, the second protruding edge 28 extends away from the second recess 21. By arranging a first protruding edge 14 on the first plate 10 and a second protruding edge 28 on the second plate 20, the first plate 10 and the second plate 20 are respectively configured into a boat-shaped structure. The first protruding edge 14 and the second protruding edge 28 are interconnected. The provision of the first protruding edge 14 and the second protruding edge 28 facilitates the installation and overlapping of the first plate 10 and the second plate 20, improves the structural stability and sealing performance after the connection of the first plate 10 and the second plate 20, and also facilitates the installation and overlapping of the first plate 10 and the second plate 20 with external structures.

According to one embodiment of the present application, the second protruding edge 28 is arranged on the side of the first protruding edge 14 closest to the second bottom wall 22 and the first protruding edge 14 and the second protruding edge 28 are arranged opposite each other, thereby enabling the first protruding edge 14 and the second protruding edge 28 to be stacked. The first protruding edge 14 and the second protruding edge 28 are fixedly connected. In some embodiments, the first protruding edge 14 and the second protruding edge 28 can be connected by brazing, which not only enhances the stability of the connection between the first plate 10 and the second plate 20, but also ensures the sealing of the connection between the first plate 10 and the second plate 20. At the same time, by providing the first protruding edge 14 and the second protruding edge 28, it is also beneficial for the installation and overlapping of the first plate 10 and the second plate 20 with external structures.

In summary, according to the heat exchange structure 100 of the embodiments of this application, by arranging a first recess 11 on the first plate 10 and a second recess 21 on the second plate 20, the first bottom wall 12 of the first plate 10 and the second bottom wall 22 of t he second plate 20 can be spaced apart to form a flow channel 29, and the first plate 10 and the second plate 20 can function as or constitute a cooler. At the same time, the battery cells 200 are placed in the first recess 11 to achieve cooling and heat dissipation. The first plate 10 and the second plate 20 are integrated into a heat exchange structure 100 with dual functions of a tray and a cooler, eliminating the tray structure, reducing weight and cost, and improving the air tightness of the heat exchange structure 100. At the same time, by installing the cushioning member 40, which possesses thermal insulation, cushioning, impact resistance, and light weight properties, effective protection can be provided to the bottom of the battery cell 200. Additionally, by assembling the bottom guard plate 50, good protection can be achieved for the bottom of the heat exchange structure 100, resulting in excellent bottom protection.

Of course, for a person having ordinary skill in the art, other structures and their working principles of the heat exchange structure 100 are understandable and achievable, and will not be elaborated in detail in this application.

According to the second aspect of the present application, a battery pack 1000 is provided, which includes the heat exchange structure 100 described in the aforementioned embodiments. Since the heat exchange structure 100 according to the embodiments of the present application has the aforementioned technical effects, the battery pack 1000 according to the embodiments of the present application can also achieve corresponding technical effects. That is, the battery pack 1000 of the present application adopts the heat exchange structure 100, by arranging a first recess 11 on the first plate 10 of the heat exchange structure 100 and a second recess 21 on the second plate 20 of the heat exchange structure 100, the first bottom wall 12 of the first plate 10 and the second bottom wall 22 of the second plate 20 can be spaced apart to form a flow channel 29, and the first plate 10 and the second plate 20 can function as or constitute a cooler. At the same time, the battery cells 200 are placed in the first recess 11 to achieve cooling and heat dissipation. The first plate 10 and the second plate 20 are integrated into a heat exchange structure 100 with dual functions of a tray and a cooler, eliminating the tray structure, reducing weight and cost of the battery pack 1000. At the same time, by installing the cushioning member 40, which possesses thermal insulation, cushioning, impact resistance, and light weight properties, effective protection can be provided to the battery pack 1000. Additionally, by assembling the bottom guard plate 50, good protection can be achieved for the bottom of the battery pack 1000, resulting in excellent bottom protection, and enhancing the thermal insulation, cushioning, and impact resistance performance of the battery pack 1000.

According to one embodiment of the present application, the battery pack 1000 further includes a battery cell 200 and a cover plate 300.

In some embodiments, the battery cell 200 is installed and arranged within the first recess 11. The cover plate 300 covers the first plate 10.

That is to say, the battery pack 1000 further includes a battery cell 200 and a cover plate 300. Among them, the battery cell 200 can be installed and arranged within the first recess 11. The heat exchange structure 100 with the flow channel 29 composed of the first plate 10 and the second plate 20 can not only serve as a cooler to achieve cooling and heat dissipation of the battery cells 200, but also as a tray to install and accommodate the battery cells 200. By setting up the filler 30, it can not only improve the load-bearing capacity of the battery pack 1000, but also provide good protection for the battery pack 1000 due to its light weight, thermal insulation, cushioning, and impact resistance performance. By filling the recessed area 26 of the second bottom wall 22 with the cushioning member 40, the bottom of the battery cell 200 can be effectively protected, further enhancing the safety of the battery pack 1000. The cover plate 300 can cover the first plate 10 of the heat exchange structure 100, enclosing the battery cell 200 within the heat exchange structure 100 and ensuring the integrity of the overall structure of the battery pack 1000.

In summary, the battery pack 1000 according to the embodiments of the present application, arranges a first recess 11 on the first plate 10 of the heat exchange structure 100 and a second recess 21 on the second plate 20 of the heat exchange structure 100, with the first bottom wall 12 of the first plate 10 and the second bottom wall 22 of the second plate 20 being spaced apart to form a flow channel 29, and the first plate 10 and the second plate 20 constituting a cooler. At the same time, the battery cells 200 are placed in the first recess 11 to achieve cooling and heat dissipation. The first plate 10 and the second plate 20 are integrated into a heat exchange structure 100 with dual functions of a tray and a cooler, eliminating the tray structure, reducing weight and cost of the battery pack 1000. At the same time, by installing the cushioning member 40, which possesses thermal insulation, cushioning, impact resistance, and light weight properties, effective protection can be provided to the battery pack 1000. Additionally, by assembling the bottom guard plate 50, good protection can be achieved for the bottom of the battery pack 1000, resulting in excellent bottom protection, and enhancing the thermal insulation, cushioning, and impact resistance performance of the battery pack 1000.

Of course, for a person having ordinary skill in the art, other structures and their working principles of the battery pack 1000 are understandable and achievable, and will not be elaborated in detail in this application.

According to the third aspect of the embodiments of the present application, an electric device is provided, which includes the heat exchange structure 100 in the above embodiments, or includes the battery pack in the above embodiments. Since the heat exchange structure 100 or battery pack according to the embodiments of the present application has the above technical effects, the electric device according to the embodiments of the present application can also have corresponding technical effects. That is, the electric device of the present application adopts the heat exchange structure 100 or battery pack, by arranging a first recess 11 on the first plate 10 of the heat exchange structure 100 and a second recess 21 on the second plate 20 of the heat exchange structure 100, with the first bottom wall 12 of the first plate 10 and the second bottom wall 22 of the second plate 20 being spaced apart to form a flow channel 29, and the first plate 10 and the second plate 20 constituting a cooler. At the same time, the battery cells 200 are placed in the first recess 11, achieving cooling and heat dissipation for the battery cells 200 in the battery pack of the electric device. The first plate 10 and the second plate 20 are integrated into a heat exchange structure 100 with dual functions of a tray and a cooler, eliminating the tray structure, reducing weight and cost of the electric device. At the same time, by installing the cushioning member 40, which possesses thermal insulation, cushioning, impact resistance, and light weight properties, effective protection can be provided to the electric device, improving the safety of the electric device. Additionally, by assembling the bottom guard plate 50, good protection can be achieved for the bottom of the battery pack, resulting in excellent bottom protection, and enhancing the thermal insulation, cushioning, and impact resistance performance of the electric device.

Of course, for a person having ordinary skill in the art, other structures and their working principles of the electric device are understandable and achievable, and will not be elaborated in detail in this application.

Although some specific embodiments of the present application have been described in detail through examples, those persons having ordinary skill in the art should understand that the above examples are merely for illustration purposes and are not intended to limit the scope of the present application. Those persons having ordinary skill in the art should also understand that the above embodiments can be modified without departing from the scope and spirit of the present application. The scope of the present application is defined by the appended claims.

Reference numerals provided herein are represented as follows: heat exchange structure 100, first plate 10, first recess 11, first bottom wall 12, first side wall 13, first protruding edge 14, second plate 20, second recess 21, second bottom wall 22, second side wall 23, protrusion 24, flow channel groove 25, recessed area 26, cavity 27, second protruding edge 28, flow channel 29, filler 30, cushioning member 40, bottom guard plate 50, battery cell 200, cover plate 300, battery pack 1000.

1. A heat exchange structure, comprising:
a first plate and a first recess arranged at the first plate, the first recess being defined by a first bottom wall and a first side wall of the first plate;
a second plate and a second recess arranged at the second plate, the second recess being defined by a second bottom wall and a second side wall,
wherein the first bottom wall and the second bottom wall are at least partially spaced apart to form a flow channel, wherein the first side wall is connected to the second side wall, and wherein the first recess of the first plate is configured to contain battery cells.

2. The heat exchange structure according to claim 1, wherein:
a protrusion is arranged at the second bottom wall, the protrusion abuts against the first bottom wall, and the first bottom wall and the protrusion are at least partially spaced apart to form the flow channel.

3. The heat exchange structure according to claim 2, wherein:
a flow channel groove is arranged on the protrusion, and the flow channel groove and the first bottom wall jointly define the flow channel.

4. The heat exchange structure according to claim 2, wherein:
the protrusion is one of a plurality of protrusions, and each protrusion of the plurality of protrusions extends along a portion of the second bottom wall.

5. The heat exchange structure according to claim 2, wherein:
a portion of the second bottom wall excluding the protrusion is spaced apart from the first bottom wall to form a cavity, and a filler is arranged inside the cavity.

6. The heat exchange structure according to claim 5, wherein:
the first side wall and the second side wall are partially spaced apart, and the second bottom wall and the second side wall cooperate with the first bottom wall and the first side wall to form the annular cavity, with the filler being a filling block corresponding to the annular cavity.

7. The heat exchange structure according to claim 6, wherein:
a side of the second bottom wall facing away from the first bottom wall is formed with a recessed area corresponding to the protrusion, and a cushioning member is arranged within the recessed area.

8. The heat exchange structure according to claim 6, wherein:
a side of the second bottom wall (facing away from the first bottom wall is formed with a recessed area corresponding to the protrusion, a cushioning member is arranged at the side of the second bottom wall (facing away from the first bottom wall, and a part of the cushioning member is located within the recessed area.

9. The heat exchange structure according to claim 7, further comprising:
a bottom guard plate, wherein the bottom guard plate is connected to the side of the second bottom wall facing away from the first bottom wall.

10. The heat exchange structure according to claim 9, wherein the bottom guard plate is fixedly connected to the portion of the second bottom wall excluding the recessed area, and the bottom guard plate abuts against the cushioning member.

11. The heat exchange structure according to claim 1, wherein:
a first protruding edge extending away from the first recess is arranged on the first side wall, and a second protruding edge extending away from the second recess is arranged on the second side wall of the second plate, with the first protruding edge and the second protruding edge being connected and configured for connecting to an external structure.

12. The heat exchange structure according to claim 11, wherein:
the second protruding edge is arranged on a side of the first protruding edge closest to the second bottom wall, the first protruding edge and the second protruding edge are arranged opposite to each other, and the first protruding edge and the second protruding edge are fixedly connected.

13. A battery pack, comprising the heat exchange structure according to claim 1.

14. The battery pack according to claim 13, further comprising:
a battery cell, which is installed and arranged within the first recess; and
a cover plate, wherein the cover plate covers the first plate.

15. An electric device, comprising the heat exchange structure according to claim 1 or a battery pack including the heat exchanger.
